(19) United States
(12) Patent Application Publication
(10) Pub. No.: US 2025/0229548 A1
(43) Pub. Date: Jul. 17, 2025

(54) SHEET DRYING APPARATUS AND IMAGE FORMING SYSTEM PROVIDED THEREWITH

(71) Applicant: KYOCERA Document Solutions Inc., Osaka (JP)

(72) Inventors: Minoru TOKONAMI, Osaka (JP); Masaki MURASHIMA, Osaka (JP); Hiroyuki UEDA, Osaka (JP); Mitsuhiro GODA, Osaka (JP)

(73) Assignee: KYOCERA Document Solutions Inc., Osaka (JP)

(21) Appl. No.: 19/015,051

(22) Filed: Jan. 9, 2025

(30) Foreign Application Priority Data
Jan. 17, 2024 (JP) 2024-005586

(51) Int. Cl. B41J 11/00

(52) U.S. Cl. CPC B41J 11/0022; B41J 11/00216; B41J 11/007; B41J 11/0085

(57) ABSTRACT

A sheet drying apparatus includes a conveyance portion, a drying portion, and a preliminary drying portion. The conveyance portion conveys a sheet on which an image is formed with ink containing moisture. The drying portion is arranged opposite the conveyance portion and heats and dries the sheet. The preliminary drying portion is arranged adjacently upstream of the drying portion with respect to the conveyance direction of the sheet, and preliminarily dries the sheet.

### INCORPORATION BY REFERENCE

This application is based on and claims the benefit of priority from Japanese Patent Application No. 2024-005586 filed on Jan. 17, 2024, the contents of which are hereby incorporated by reference.

### BACKGROUND

The present disclosure relates to a sheet drying apparatus that dries sheets on which images have been printed in an inkjet recording apparatus or the like, and to an image forming system provided with such a sheet drying apparatus.

As recording apparatuses such as facsimile machines, copiers, and printers, inkjet recording apparatuses, which form images by ejecting ink onto a sheet, are widely used. Sheet drying apparatuses are known for heating and drying sheets (paper) on which ink has been adhered by inkjet recording apparatuses.

### SUMMARY

According to one aspect of the present disclosure, a sheet drying apparatus includes a conveyance portion, a drying portion, and a preliminary drying portion. The conveyance portion conveys a sheet on which an image is formed with ink containing moisture. The drying portion is arranged opposite the conveyance portion and heats and dries the sheet. The preliminary drying portion is arranged adjacently upstream of the drying portion with respect to a conveyance direction of the sheet, and preliminarily dries the sheet.

### BRIEF DESCRIPTION OF THE DRAWINGS

FIG. 1 is a schematic diagram showing the internal construction of an image forming system including a sheet drying apparatus of the present disclosure.

FIG. 2 is a side sectional view around a drying portion in a sheet drying apparatus according to one embodiment of the present disclosure.

FIG. 3 is an enlarged view of the drying portion in FIG. 2.

FIG. 4 is a sectional perspective view showing the construction around a preliminary drying portion and the drying portion in the sheet drying apparatus.

FIG. 5 is a side sectional view around the preliminary drying portion and the drying portion in the sheet drying apparatus as cut along the conveyance direction.

FIG. 6 is a side sectional view around the preliminary drying portion and the drying portion as cut along the conveyance direction, showing the flow of hot air from the drying portion when the sheet blowing fan is off.

FIG. 7 is a side sectional view around the preliminary drying portion and the drying portion as cut along the conveyance direction, showing the flow of hot air from the drying portion when the sheet blowing fan is on.

### DETAILED DESCRIPTION

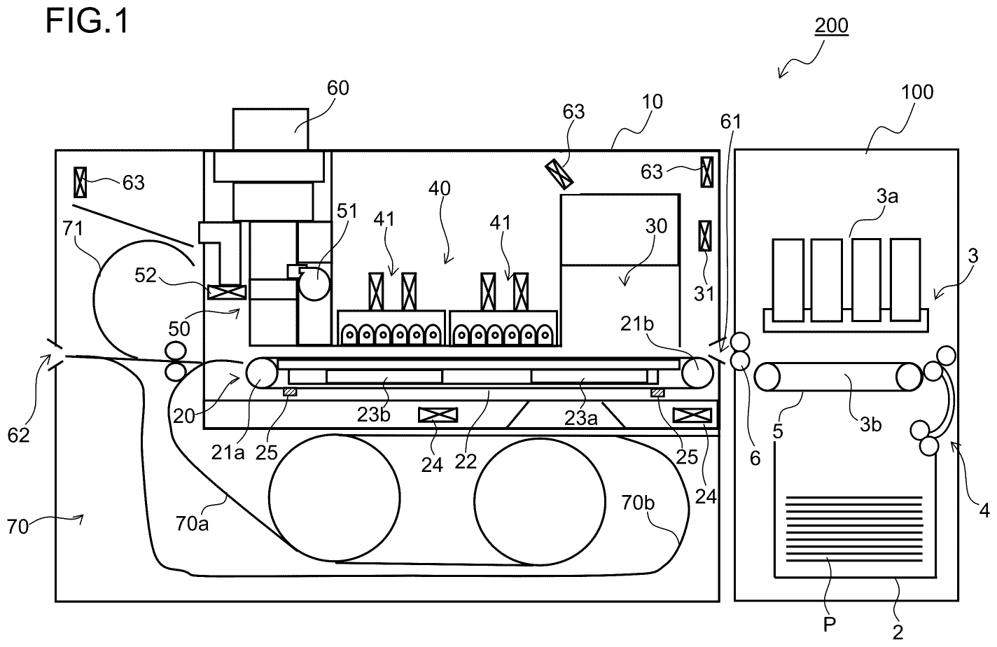

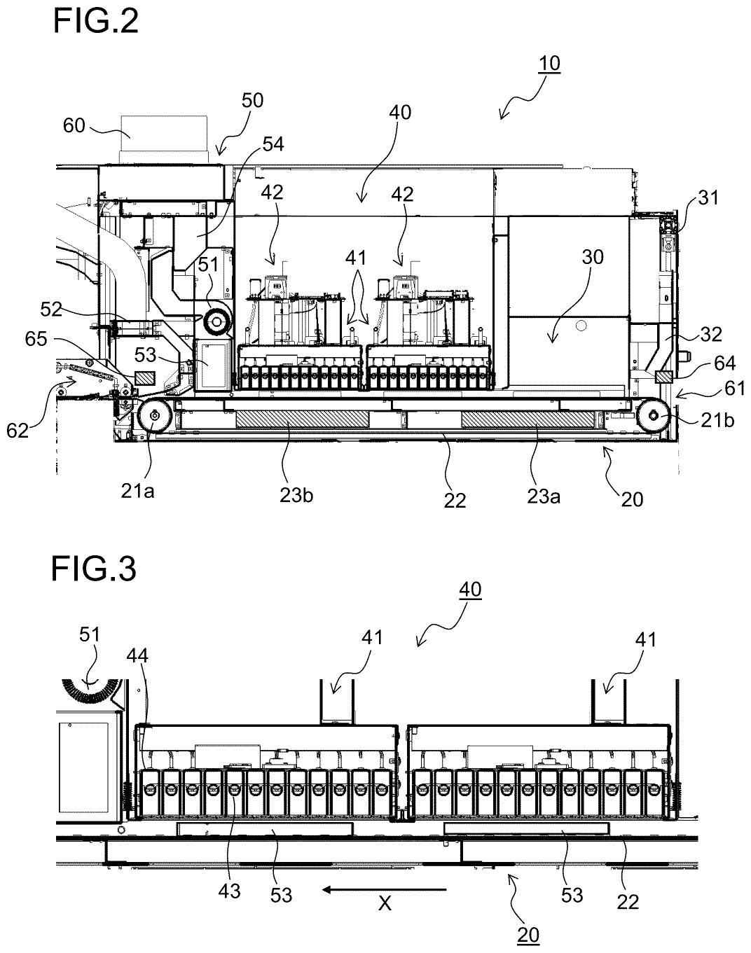

1. Construction of an Image Forming System Including a Sheet Drying Apparatus: An embodiment of the present disclosure will be described below with reference to the accompanying drawings. FIG. 1 is a schematic diagram showing the internal construction of an image forming system 200 including a sheet drying apparatus 10 of the present disclosure. FIG. 2 is a side sectional view around a drying portion 40 in the sheet drying apparatus 10 according to one embodiment of the present disclosure. The image forming system 200 configured with an image forming apparatus 100 and the sheet drying apparatus 10 will be described with reference to FIGS. 1 and 2.

The image forming apparatus 100 is an inkjet recording printer and includes a sheet storage portion 2 arranged in a bottom part of the image forming apparatus 100, an image forming portion 3 arranged above the sheet storage portion 2, and a sheet feed portion 4 that feeds a sheet P stored in the sheet storage portion 2 to the image forming portion 3.

The image forming portion 3 is configured with a recording portion 3a having a plurality of recording heads and a print conveyance portion 3b arranged opposite the recording portion 3a. The print conveyance portion 3b includes an endless print conveyance belt 5 stretched around a plurality of rollers including a driving roller. The sheet P conveyed by the sheet feed portion 4 is conveyed below the recording portion 3a by being held under suction on the print conveyance belt 5 by a sheet suction portion (not shown) arranged inward of the print conveyance belt 5. The sheet P having a predetermined image recorded to it by the image forming portion 3 is discharged through a pair of discharge rollers 6 and is conveyed into the sheet drying apparatus 10.

The sheet drying apparatus 10 is arranged adjacent to the image forming apparatus 100 and dries the ink on the sheet P discharged from the image forming apparatus 100. The sheet drying apparatus 10 includes a first conveyance portion 20, a preliminary drying portion 30, a drying portion 40, a suction fan unit 50, and a second conveyance portion 70.

The first conveyance portion 20 includes a driving roller 21a, a driven roller 21b, and a conveyance belt 22. The conveyance belt 22 is stretched around the driving roller 21a arranged on the downstream side and the driven roller 21b arranged on the upstream side with respect to the conveyance direction of the sheet P (right to left direction in FIG. 1; hereinafter, referred to simply as the conveyance direction).

Inward of the conveyance belt 22 is arranged sheet suction portions 23a and 23b. In the conveyance belt 22, many suction holes (not shown) are formed through which to pass suction air for sucking the sheet P onto the conveyance belt 22 by negative pressure suction by the sheet suction portions 23a and 23b.

Belt cooling fans 24 are arranged at two places below the conveyance belt 22. A belt temperature sensor 25 is arranged adjacent to a bottom face of the conveyance belt 22. The belt cooling fan 24 blows cooling air to the conveyance belt 22 when the sensed temperature of the belt temperature sensor 25 reaches or exceeds a predetermined temperature.

The preliminary drying portion 30 is arranged closely downstream of a sheet loading port 61 with respect to the conveyance direction and preliminarily dries the ink on the sheet P conveyed in through the sheet loading port 61. The preliminary drying portion 30 includes a sheet blowing fan 31 and a sheet blowing duct 32 for blowing air from above the sheet P.

The drying portion 40 is arranged adjacently downstream of the preliminary drying portion 30 with respect to the conveyance direction and dries the ink on the sheet P having passed through the preliminary drying portion 30. The drying portion 40 includes two heating units 41 arranged on a top surface of the conveyance belt 22 so as to face each other.

The suction fan unit 50 sucks in the water vapor emanating from the sheet P passing through the drying portion 40. The suction fan unit 50 includes a suction fan 51 that sucks in air containing water vapor inside the drying portion 40 and a separation fan 52 that blows separation air for separating the sheet P from the conveyance belt 22. The suction fan unit 50 communicates with a space between the conveyance belt 22 and the heating unit 41 via a first duct 53 and communicates with an exhaust port 60 formed in a top part of the sheet drying apparatus 10 via a second duct 54.

A plurality of ambient air intake fans 63 for taking in ambient air into the sheet drying apparatus 10 are arranged at appropriate places in the sheet drying apparatus 10. In an upstream and a downstream part of the first conveyance portion 20 are arranged sheet detection sensors 64 and 65. The sheet detection sensors 64 and 65 detect the sheet P having passed through the sheet loading port 61 and the sheet discharge port 62.

As, by being driven to rotate by the driving roller 21a, the conveyance belt 22 rotates in the counterclockwise direction, the sheet P conveyed in through the sheet loading port 61 passes through the preliminary drying portion 30 and then through the drying portion 40 to be discharged through the sheet discharge port 62 out of the sheet drying apparatus 10 or conveyed into the second conveyance portion 70.

The second conveyance portion 70 is arranged below the drying portion 40 and the preliminary drying portion 30 across the first conveyance portion 20. The second conveyance portion 70 includes a reversing conveyance passage 70a, for reversing top side down the sheet P on which the ink has been dried, and a duplex conveyance passage 70b, for returning, when duplex printing is performed on the sheet P, the sheet P reversed top side down to the image forming apparatus 100.

Downstream (left side in FIG. 1) of the suction fan unit 50 with respect to the conveyance direction is provided a retraction path 71 in the shape of an arc. The retraction path 71 is where a sheet P (waste sheet) that has become useless due to a printing defect or the like in the image forming apparatus 100 is retracted and stored.

2. Construction of the Sheet Drying Apparatus: FIG. 3 is an enlarged view of the drying portion 40 in FIG. 2. The drying portion 40 includes a heating unit 41 and a hot air fan 42 (see FIG. 2). Two heating units 41 are arranged along the conveyance direction (arrow-X direction). The heating unit 41 include a heater 43 and a reflector 44.

The heater 43 is in the shape of a bar extending in the sheet width direction (the direction orthogonal to the plane in FIG. 3; hereinafter, referred to simply as the width direction) horizontally orthogonal to the conveyance direction. In the heating unit 41, a plurality (12 in this embodiment) of heaters 43 are arranged side by side along the conveyance direction. In this embodiment, an infrared heater is used as the heater 43.

The reflector 44 is a reflector plate U-shaped as seen in a side view arranged so as to surround the heater 43 from above. The infrared rays emitted from the heater 43 are reflected downward by the inner surface of the reflector 44 and are shone onto the sheet P carried and conveyed on the conveyance belt 22. Thus, the moisture in the ink on the sheet P evaporates and the ink dries; thus, the ink is fixed to the sheet P.

The hot air fan 42 is arranged above the heating unit 41. More specifically, the hot air fan 42 is arranged so as to blow air from above toward the reflectors 44. The air blown from the hot air fan 42 onto the reflectors 44 is heated as it passes through the gaps between the reflectors 44 become hot air to flow into the gap (drying space) between the heating unit 41 and the conveyance belt 22.

If steam or water vapor is present in the gap between the heating unit 41 and the conveyance belt 22, the infrared rays emitted from the heater 43 and reflected from the reflector 44 are absorbed by the steam or water vapor and this impairs their ability to dry the ink on the sheet P. Thus, by operating the hot air fan 42 to blow hot air into the gap between the heating unit 41 and the conveyance belt 22 and scattering and removing the steam or water vapor emanating from the sheet P, it is possible to maintain the drying properties of the ink under infrared rays.

Between the drying portion 40 and the suction fan unit 50, a first duct 53 is provided for sucking the steam or water vapor emanating from the sheet P together with air. The first duct 53 extends from the gap between the heating unit 41 and the conveyance belt 22 to the suction fan 51 in the suction fan unit 50.

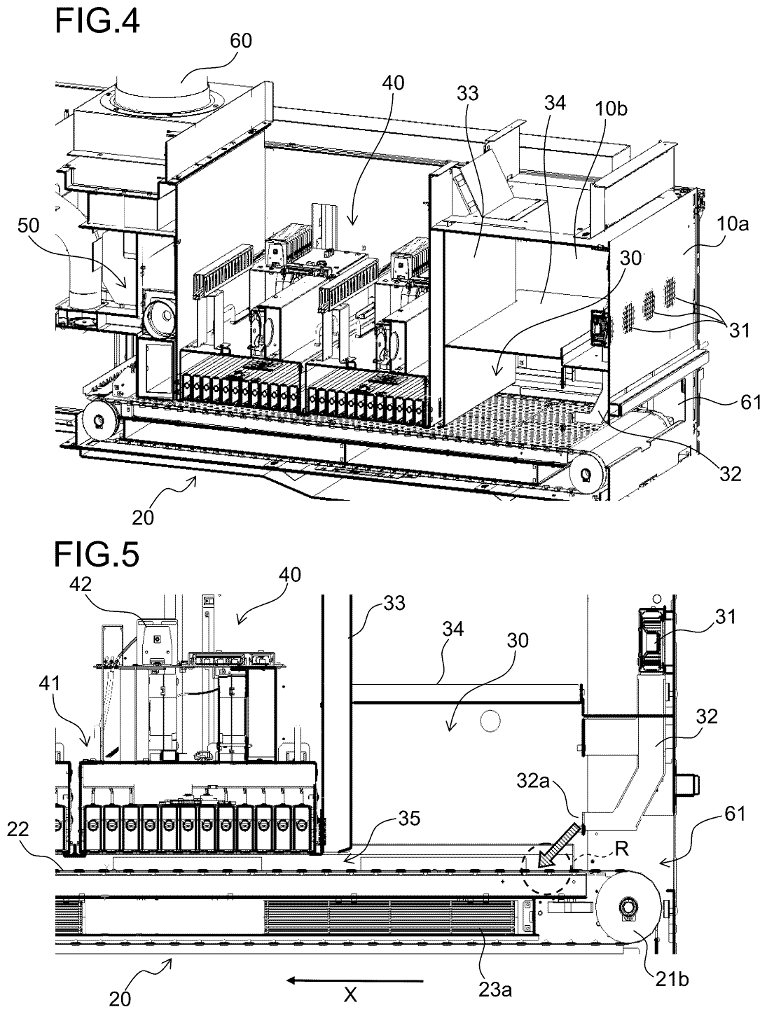

3. Construction of the Preliminary Drying Portion: FIG. 4 is a sectional perspective view showing the construction around the preliminary drying portion 30 and the drying portion 40 in the sheet drying apparatus 10. FIG. 5 is a side sectional view around the preliminary drying portion 30 and the drying portion 40 as cut along the conveyance direction.

As shown in FIGS. 4 and 5, the preliminary drying portion 30 is partitioned by a first partition wall 33 arranged on the upstream side of the drying portion 40 with respect to the conveyance direction (arrow X direction), a second partition wall 34 that extends horizontally from substantially a middle part of the first partition wall 33 in the vertical direction toward the upstream side in the conveyance direction, and a side frame 10a, a rear frame 10b, and a front frame (not shown) of the sheet drying apparatus 10.

On the side frame 10a, the sheet blowing fan 31 is arranged. Three sheet blowing fans 31 are arranged above the second partition wall 34, along the width direction of the side frame 10a. To the sheet blowing fan 31, the blowing duct 32 is coupled.

The blowing duct 32 extends from the sheet blowing fan 31 toward the conveyance belt 22 within the preliminary drying portion 30. At an end of the blowing duct 32, a blowing port 32a opens toward the downstream side in the conveyance direction.

The ambient air taken in from outside the sheet drying apparatus 10 by the sheet blowing fan 31 passes through the blowing duct 32 and is blown out through the blowing port 32a obliquely downward (hatched arrow direction in FIG. 5) from the upstream side in the conveyance direction toward a space (non-suction space R) upstream of the sheet suction portion 23a of the conveyance belt 22 in the conveyance direction. This prevents the floating up of the trailing end of the sheet P being delivered from the sheet loading port 61 to the conveyance belt 22.

Between a lower end part of the first partition wall 33 and the conveyance belt 22 is formed a gap 35. The hot air blown by the hot air fan 42 into the gap between the heating unit 41 and the conveyance belt 22 passes through the gap 35 and flows into the preliminary drying portion 30. This hot air heats and preliminarily dries the sheet P passing through the preliminary drying portion 30.

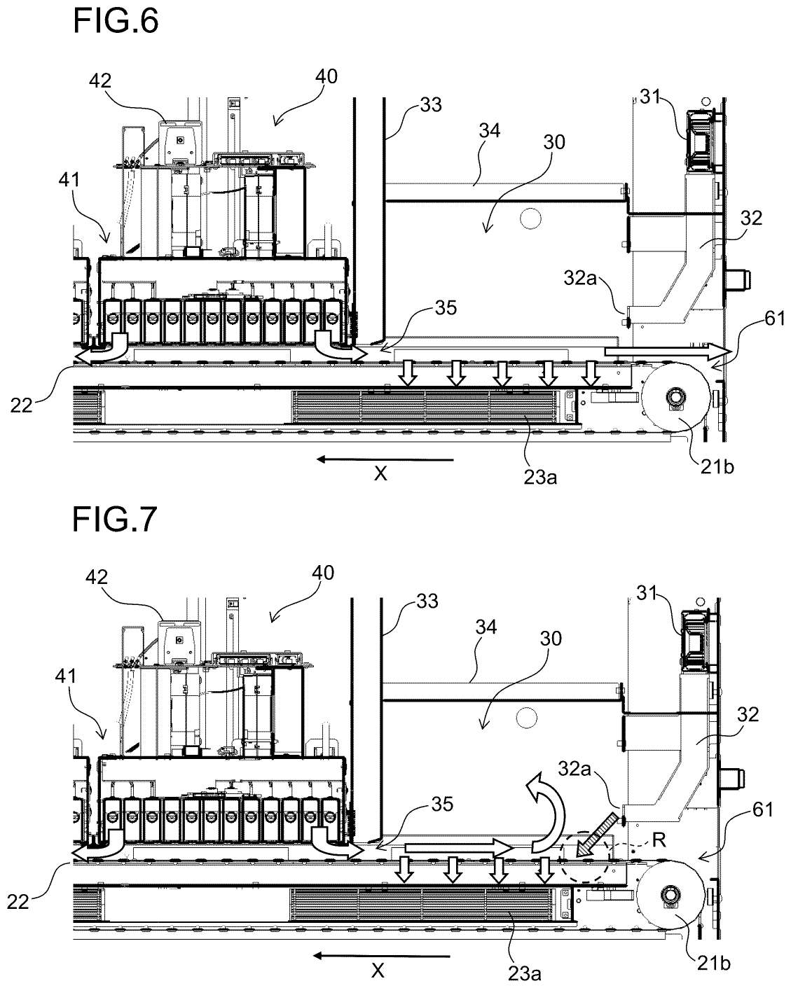

FIGS. 6 and 7 are side sectional views around the preliminary drying portion 30 and the drying portion 40 as cut along the conveyance direction, showing the flow of the hot air from the drying portion 40 when the sheet blowing fan 31 is off and on, respectively. In FIGS. 6 and 7, the flow of the hot air is indicated by hollow arrows.

The hot air blown downward by the hot air fan 42 from above into the gap between the heating unit 41 and the conveyance belt 22 changes its direction to horizontally along the top face of the conveyance belt 22. At the front and rear of the drying portion 40 lie the front frame (not shown) and the rear frame 10b (see FIG. 4). Thus, the hot air flows toward the upstream (right side in FIGS. 6 and 7) and downstream (left side in FIGS. 6 and 7) in the conveyance direction along the top face of the conveyance belt 22. The hot air flowing upstream in the conveyance direction passes through the gap 35 at the lower end part of the first partition wall 33 and flows into the preliminary drying portion 30.

When the sheet blowing fan 31 is off, as shown in FIG. 6, part of the hot air having flowed into the preliminary drying portion 30 passes through the suction holes (not shown) formed in the conveyance belt 22 and flows out downward by negative pressure suction by the sheet suction portion 23a. On the other hand, a large part of the hot air flows through the preliminary drying portion 30, along the conveyance belt 22, toward upstream in the conveyance direction. Then the hot air flows through the sheet loading port 61 out of the sheet drying apparatus 10. That is, the hot air having flowed from the drying portion 40 into the preliminary drying portion 30 promptly flows out of the preliminary drying portion 30, and this results in low efficiency of the primary drying of the sheet P in the preliminary drying portion 30.

When the sheet blowing fan 31 is on, as shown in FIG. 7, the air is blown through the blowing port 32a of the blowing duct 32 obliquely downward in the conveyance direction (hatched arrow direction in FIG. 5) toward the non-suction space R. Thus, the hot air flowing toward the sheet loading port 61 and the air blown from the blowing duct 32 collide with each other and the hot air changes its direction to upward in the preliminary drying portion 30.

As a result, the hot air flowing out of the preliminary drying portion 30 contains only the hot air that passes through the suction holes in the conveyance belt 22 and flows out downward. It is thus possible to prevent the heat in the preliminary drying portion 30 from being rejected to the outside.

With the configuration according to the embodiment, the preliminary drying portion 30 is provided upstream of the drying portion 40 in the conveyance direction to raise the temperature of the sheet P and preliminarily dry it, and this helps prevent blisters with no loss in the condition of sheets conveyed or in safety.

The air blown from the sheet blowing fan 31 to prevent the sheet P from floating up in the non-suction space R on the conveyance belt 22 and the hot air flowing in the preliminary drying portion 30 collide with each other from opposite directions, and this makes the hot air less likely to flow out of the preliminary drying portion 30. This helps enhance the efficiency of the primary drying of the sheet P in the preliminary drying portion 30.

The present disclosure can be implemented in any manner other than as in the embodiment described above, and allows for any modifications without departure from the spirit of the present disclosure. For example, while the embodiment described above deals with a configuration where the sheet drying apparatus 10 is coupled to, as an example of the image forming system 200, an inkjet printer as an image forming apparatus 100, needles to say, the sheet drying apparatus 10 can be used independently without the image forming apparatus 100 coupled to it.

The present disclosure finds applications in sheet drying apparatuses that dry sheets on which images have been printed in inkjet recording apparatuses and the like. Based on the present disclosure, it is possible to provide a sheet drying apparatus that prevents blisters with no loss in the condition of sheets conveyed or in safety, and to provide an image forming system provided with such a sheet drying apparatus.

What is claimed is:

1. A sheet drying apparatus comprising:
a conveyance portion that conveys a sheet on which an image is formed with ink containing moisture;
a drying portion arranged opposite the conveyance portion, the drying portion heating and drying the sheet; and
a preliminary drying portion arranged adjacently upstream of the drying portion with respect to a conveyance direction of the sheet, the preliminary drying portion preliminarily drying the sheet.

2. The sheet drying apparatus according to claim 1, wherein
the drying portion includes
a heating unit having a plurality of infrared heaters arranged opposite the conveyance portion and a plurality of reflectors that surround the infrared heaters from a direction opposite to the conveyance portion and
a hot air fan arranged opposite the conveyance portion across the heating unit, the hot air fan blowing toward the conveyance portion hot air heated as a result of air passing through a gap from the reflectors,
wherein
the hot air blown toward the conveyance portion passes upstream in the conveyance direction through a gap in a partition wall formed between the drying portion and the preliminary drying portion and flows into the preliminary drying portion.

3. The sheet drying apparatus according to claim 2, wherein
the conveyance portion includes
a conveyance belt that carries and conveys the sheet and
a suction portion that carries the sheet while sucking the sheet onto the conveyance belt by negative pressure suction via a number of suction holes formed in the conveyance belt,
wherein
the sheet drying apparatus further comprises:
a sheet blowing fan that sucks in air outside the sheet drying apparatus and
a blowing duct that communicates the sheet blowing fan with inside the preliminary drying portion,
the air sucked in by the sheet blowing fan and having passed through the blowing duct is blown, as blowing air for preventing the sheet from floating up in a non-suction space upstream of the suction portion of the conveyance belt in the conveyance direction, obliquely downward toward the non-suction space, downstream in the conveyance direction, and
the blowing air and the hot air having flowed into the preliminary drying portion collide with each other.

4. An image forming system comprising:
an image forming apparatus that performs image formation on a sheet with ink containing moisture; and
the sheet drying apparatus according to claim 1 that is coupled to the image forming apparatus at a downstream side thereof in the conveyance direction of the sheet, the sheet drying apparatus drying the sheet on which an image is formed by the image forming apparatus.
